(19) United States
(12) Patent Application Publication
(10) Pub. No.: US 2025/0316929 A1
(43) Pub. Date: Oct. 9, 2025

(54) PLUG-IN CONNECTOR ASSEMBLY

(71) Applicant: Robert Bosch GmbH, Stuttgart (DE)

(72) Inventor: Thorsten Kremer, Gerlingen (DE)

(21) Appl. No.: 18/865,532

(22) PCT Filed: May 15, 2023
(86) PCT No.: PCT/EP2023/062909

§ 371 Date: Jan. 17, 2025

(30) Foreign Application Priority Data
May 13, 2022 (DE) 10 2022 204 731.1

(51) Int. Cl. H01R 13/629

(52) U.S. Cl. CPC H01R 13/62938; H01R 13/62955

(57) ABSTRACT

A plug-in connector assembly. The assembly includes: a plug-in connector with a plug-in connector housing; a mating plug-in connector with a mating plug-in connector housing; an actuation element; a CPA. The plug-in connector has a plugged position relative to the mating plug-in connector and can be plugged to the mating plug-in connector from a starting plugged position up to a final plugged position along a plugging direction. The actuation element can be displaced between a first position and a second position and is designed to reduce a plug-in force when connecting the plug-in connector to the mating plug-in connector. When the actuation element is displaced from the first position to the second position, the plug-in connector is displaced from the starting plugged position to the final plugged position. The CPA can be displaced between an unlocking position and a locking position.

### FIELD

The present invention relates to a plug-in connector assembly. It furthermore relates to a plug-in connector for a plug-in connector assembly. It furthermore relates to a mating plug-in connector for a plug-in connector assembly.

### BACKGROUND INFORMATION

In the field of plug-in connector assemblies, which can be plugged together from a plug-in connector and a mating plug-in connector, it is important not to exceed a certain plug-in force when plugging them together from a starting plugged position to a final plugged position. In the case of multi-pin plug-in connectors and/or in the case of plug-in connectors for high-current applications, e.g., for electric vehicles, the plug-in force may exceed a desired level.

In order to reduce the plug-in forces, an actuation element can be provided on the plug-in connector, which actuation element can be displaced between a first position and a second position and is designed to reduce a plug-in force when connecting the plug-in connector to the mating plug-in connector, wherein, when the actuation element is displaced from the first position to the second position, the plug-in connector is displaced to the final plugged position.

It can be advantageous for an operator if the plug-in connector assembly has an element which indicates that the actuation element has reached the second position or which can only be displaced if the second position has been reached. Such elements are usually referred to as CPA (connector position assurance). They may, for example, be displaceable between an unlocking position and a locking position along a displacement direction and, in the locking position, block the actuation element from moving from the second position to the first position.

Such plug-in connector assemblies with various actuation elements are described in European Patent Application No. EP 0 933 836 A2, German Patent Application No. DE 10 2011 101 205 A1 and PCT Patent Application WO 02/078126 A2.

### SUMMARY

The present invention is based on the finding that, in particular in the case of high-current plugs and multi-pin plug connections which have an actuation element as described above, the CPA only indicates that the actuation element has reached the second position. Its function is thus independent of the presence of the mating contact elements (e.g., a male multipoint connector or high-current pins) of the mating plug-in connector. In this case, it is tacitly assumed that, when the actuation element has reached the second position, the plug-in connector and the mating plug-in connector are in the final plugged position and a reliable electrical and mechanical contact is thus also formed. Ultimately, it thus does not necessarily indicate an operational and safe electrical connection. The locking function of such CPAs often locks the actuation element without ensuring that the actuation element has pulled the plug to the final position on the male multipoint connector. Depending on the installation space, such incorrect assembly is difficult to detect visually and haptically. This is because the plug-in connector, CPA, actuation element and the mating plug-in connector are (apparently) in the correct position relative to one another and the actuation element can no longer be moved relative to the plug-in connector.

There may therefore be a need to provide a plug-in connector assembly with an actuation element for reducing the plug-in force and with a CPA, in which the CPA safely and reliably indicates that the mating plug-in connector is present and that the final plugged position between the plug-in connector and the mating plug-in connector has been reached correctly.

This need can be met by embodiments of the present invention. Advantageous example embodiments of the present invention are disclosed herein.

According to a first aspect of the present invention, a plug-in connector assembly is provided.

According to an example embodiment of the present invention, the plug-in connector assembly has a plug-in connector with a plug-in connector housing, a mating plug-in connector with a mating plug-in connector housing, an actuation element, and a CPA (connector position assurance). The plug-in connector has a plugged position relative to the mating plug-in connector and can be plugged to the mating plug-in connector from a starting plugged position up to a final plugged position along a plugging direction. The actuation element can be displaced between a first position and a second position and is designed to reduce a plug-in force when connecting the plug-in connector to the mating plug-in connector, wherein, when the actuation element is displaced from the first position to the second position, the plug-in connector is displaced from the starting plugged position to the final plugged position. The CPA can be displaced between an unlocking position and a locking position along a displacement direction, wherein, in the locking position, the CPA blocks the actuation element from being displaced from the second position to the first position. It is provided that the CPA and the mating plug-in connector or the plug-in connector are configured or designed relative to each other in such a way that, depending on the plugged position, the displacement of the CPA from the unlocking position to the locking position is blocked.

For example, it may also be provided that, depending on the plugged position, the displacement of the CPA from the unlocking position to the locking position is blocked or released. For example, the release may additionally also depend on the position of the actuation element.

This has the advantageous effect that an incorrect connection between the plug-in connector and the mating plug-in connector is prevented. As a result, it is advantageously impossible for an operator to displace the CPA, which can be displaced from the unlocking position to the locking position as a sign of a correct connection, if, for example, only the actuation element is displaced to its second position. The CPA can thus actually be displaced primarily depending on the plugged position between the plug-in connector and the mating plug-in connector.

The term “starting plugged position” can be understood as any state in which the plug-in connector and the mating plug-in connector are not yet plugged together or have at most come into loose contact with each other or have not yet moved toward each other. In particular, the term “starting plugged position” can also be understood as a state of the plug-in connector in which the plug-in connector has not even been placed on the mating plug-in connector or is not yet in mechanical contact with the mating plug-in connector. For example, the plug-in connector may be provided in the starting plugged position (e.g., attached to a cable harness) in order then, starting from this starting plugged position, to be placed on the mating plug-in connector (e.g., a male multipoint connector, e.g., of a control unit or, e.g., pins of a high-current connection, e.g., of an inverter or of a battery of an electric vehicle). The starting plugged position can thus correspond to a pre-plugged state. The starting plugged position ends when plugging together begins, e.g., by actuating the actuation element and moving the plug-in connector and the mating plug-in connector toward each other.

For example, it may be provided that the plug-in connector has (at least) one contact element.

For example, it may be provided that the mating plug-in connector has (at least) one mating contact element.

For example, it may be provided that, in the final plugged position, the contact element is electrically connected to the mating contact element. For example, it may be provided that, in the final plugged position, the plug-in connector is captively coupled to the mating plug-in connector. This means that the plug-in connector and the mating plug-in connector in any spatial alignment cannot detach from one another without external intervention, which is in particular to be performed by an operator.

For example, it may be provided that the plug-in connector and the mating plug-in connector are coupled to each other in the final plugged position, in particular are mechanically and/or electrically coupled to each other.

For example, it may be provided that, in the starting plugged position, the plug-in connector and the mating plug-in connector are not captively connected to each other or that, in the starting plugged position, the plug-in connector and the mating plug-in connector are not yet in contact with each other.

For example, it may be provided that the actuation element is arranged on the plug-in connector, in particular on the plug-in connector housing. Alternatively, it may be provided, for example, that the actuation element is arranged on the mating plug-in connector, in particular on the mating plug-in connector housing.

For example, it may be provided that the actuation element is designed to interact with a structure, which is in particular arranged on the mating plug-in connector or on the plug-in connector, in such a way that, when the actuation element is displaced from the first position to the second position, the plug-in connector is displaced from the starting plugged position to the final plugged position. For example, if arranged on the plug-in connector, the actuation element may have a guide which interacts with a structure designed as a pin on the mating plug-in connector and thus pulls the plug-in connector onto the mating plug-in connector from the starting plugged position to the final plugged position when the actuation element is displaced from the first to the second position. The structure may, for example, also be designed as a guide, gearwheel, rack, or the like. A mating structure complementary to the structure is accordingly formed on the actuation element.

In the context of this application, the term “have” is to be understood as synonymous with the term “comprise,” unless otherwise specified.

In a development of the present invention, it is provided that a displacement of the CPA from the unlocking position to the locking position is blocked before the final plugged position is reached. This has the advantageous effect that the inability to displace the CPA clearly indicates to an operator that the plug connection between the plug-in connector and the mating plug-in connector is not yet properly established. If, for example, only the actuation element is displaced (approximately) to the second position without, for example, the plug-in connector being arranged on the mating plug-in connector at all, or if the plug-in connector in such a case has not been pulled onto the mating plug-in connector, the blocking of the displacement of the CPA indicates to the operator in a simple, mechanical, haptic and visual manner that there is still an incorrect connection or that the correct connection has not been achieved.

For example, it may be provided that, in the final plugged position, a displacement of the CPA from the unlocking position to the locking position is made possible. However, it may also be provided that, in the final plugged position, only one blocking element (e.g., a latching arm) of the CPA is released from its blocking and the final displaceability of the CPA depends on further elements of the plug-in connector assembly, e.g., on a position of the actuation element.

In a development of the present invention, it is provided that the CPA is arranged on the actuation element. Advantageously, this makes the CPA particularly easy and cost-effective to produce and mount. It is provided together with the actuation element. Furthermore, this is advantageous for an operator as the CPA is always directly visible when operating the actuation element and can be actuated in one work step. This advantageously shortens the cycle time when plugging together the plug-in connector and the mating plug-in connector to form the plug-in connector assembly.

Alternatively or additionally, it is provided that the CPA is arranged on the plug-in connector, e.g., on the plug-in connector housing. This has the advantageous effect that, in a simple manner, the displaceability of the CPA can also be made dependent on the position of further elements of the plug-in connector assembly, e.g., the position of the actuation element. Another advantage is that the CPA is in this way protected against damage particularly well.

Alternatively or additionally, it is provided that the CPA is arranged on the mating plug-in connector, e.g., on the mating plug-in connector housing. This has the advantageous effect that, in a simple manner, the displaceability of the CPA can also be made dependent on the position of further elements of the plug-in connector assembly, e.g., the position of the actuation element. Another advantage is that the CPA is in this way protected against damage particularly well.

In a development of the present invention, it is provided that the actuation element is designed as a slider and/or as a lever that can be rotated about an axis. This advantageously provides an actuation element that is particularly easy to operate. In a design as a lever, the plug-in force for an operator can be adjusted and reduced particularly easily via the length of the lever.

In a development of the present invention, it is provided that the CPA has a latching element which can be latched to a mating element, wherein the latching element can be deflected between a first position and a second position. In the first position, the latching element is latched to the mating element and blocks the CPA from being displaced from the unlocking position to the locking position, wherein, in the second position, the latching element is not latched to the mating element. In the starting plugged position, the latching element is in the first position, wherein a first unlatching element is arranged on the plug-in connector housing or on the mating plug-in connector housing and is designed in such a way that, in the final plugged position, the latching element is displaced to the second position by means of the first unlatching element.

In other words, in the final plugged position, the first unlatching element displaces the latching element to the second position.

For example, it may be provided that, in the second position of the latching element, the CPA can be displaced from the unlocking position to the locking position. However, it may also be provided, for example, that whether the CPA can be displaced to the locking position depends on the position of at least one further element of the plug-in connector assembly.

The latching element may, for example, be designed to be elastically reversibly displaceable between the first position and the second position. It may, for example, be designed as a latching arm.

This advantageously results in a particularly simple, cost-effective and reliable mechanical blocking of the CPA. At the same time, this ensures that unblocking of the CPA is only possible if the CPA comes into mechanical contact with the unlatching element, which is not part of the actuation element, and that the correct connection can be determined very reliably and safely in this way.

In a development of the present invention, it is provided that the first unlatching element is designed as a projection on the plug-in connector housing or on the mating plug-in connector housing.

The projection may, for example, project outward from the plug-in connector housing or from the mating plug-in connector housing in a radial direction perpendicular to the plugging direction.

This provides a particularly simple, cost-effective and robust design for displacing the latching element to the second position. The design as a projection also has the advantageous effect that, if the plug-in connector is incorrectly placed (e.g., rotated by) 180° or if an unsuitable plug-in connector is used (e.g., a similar connector that does not fit the existing mating plug-in connector) on the mating plug-in connector, the final plugged position cannot be reached at all, since the projection acts in the manner of a key-lock principle. This advantageously improves the safety and reliability of the plug-in connector assembly, e.g., in high-current applications.

In a development of the present invention, it is provided that the latching element has a latching element projection which projects radially inward, wherein, in the final plugged position, the latching element projection is in contact with the first unlatching element and, as a result, the latching element is displaced to the second position by the first unlatching element.

The second position may, for example, be reached by displacing the latching element radially outward.

The second position may, for example, be reached when the CPA is in the unlocking position.

If the CPA is subsequently displaced from the unlocking position to the locking position, it may, for example, be provided that the latching element projection is displaced beyond the projection and the latching element leaves the second position and is, for example, displaced back to the first position (for example due to its elasticity, which makes an elastically reversible displacement from the second to the first position possible). The latching element projection may then, for example, block a displacement of the CPA from the locking position to the unlocking position by, for example, latching to the projection or another mating element or being blocked in an undercut-like manner. In such a case, in order to open the plug-in connector assembly (i.e., to separate the plug-in connector and the mating plug-in connector), it may be necessary to displace the latching element first to the second position (e.g., by tilting the CPA or by means of an unlatching element or the like) and thus to bring the latching element projection out of engagement with the projection or the other mating element.

In a development of the present invention, it is provided that the CPA and the actuation element are designed to cooperate with each other in such a way that a displaceability or a displacement of the CPA from the unlocking position to the locking position depends on a position of the actuation element, wherein, in the first position of the actuation element, the CPA cannot be displaced from the unlocking position to the locking position.

For example, it may be provided that the CPA can be displaced from the unlocking position to the locking position only if the actuation element is in the second position and the final plugged position is reached at the same time.

This has the advantageous effect that the CPA can safely and simply cause the actuation element to be locked. Furthermore, this advantageously prevents a plug-in connector without an actuation element or with a damaged actuation element from being placed on the mating plug-in connector and pushed to the final plugged position, and the CPA from already being displaceable when only the final plugged position has been reached. This furthermore has the advantageous effect that the plug-in connector and the mating plug-in connector do not detach from each other after the final plugged position has been reached. This is because the actuation element can be designed to captively secure the plug-in connector to the mating plug-in connector, e.g., by means of a self-locking effect.

However, it may also be provided that, in addition to the presence of the two above conditions, the displacement of the CPA from the unlocking position to the locking position depends on the position of a further element of the plug-in connector assembly.

In a development of the present invention, it is provided that the CPA has a further latching element that can be latched to a further mating element, wherein the further latching element can be deflected between a third position and a fourth position, wherein, in the third position, the further latching element is latched to the further mating element and blocks the CPA from being displaced from the unlocking position to the locking position, wherein, in the fourth position, the further latching element is not latched to the further mating element and the CPA can in particular be displaced from the unlocking position to the locking position, wherein, in the first position of the actuation element, the further latching element is in the third position, wherein a second unlatching element is provided and is in particular arranged on the actuation element and is designed in such a way that, in the second position of the actuation element, the further latching element is or is being displaced to the fourth position by means of the second unlatching element.

This advantageously results in a particularly simple, cost-effective and robust, in particular purely mechanical, design of the further latching element and the CPA.

It may be provided that the latching element and the further latching element are designed as a common latching element; the description as a latching element and further latching element in this case serves only to illustrate the different functionalities (e.g., blocking before reaching the final plugged position on the one hand and blocking before reaching the second position on the other hand). For example, the displacement from the first position to the second position can take place in a first direction and the displacement from the third position to the fourth position can take place in a second direction. Such a second direction may, for example, extend approximately perpendicularly to the first direction. However, it is also possible that the latching element and the further latching element are separate elements. They may, for example, be designed as two latching arms spaced apart from each other. The latching element and the further latching element may, for example, be designed to be elastically reversibly displaceable.

In a development of the present invention, it is provided that the second unlatching element is designed as a further projection on the actuation element.

This provides a particularly simple, cost-effective and robust second unlatching element.

The further projection may, for example, project from the actuation element in a radial direction perpendicular to the plugging direction.

In a development of the present invention, it is provided that the further latching element has a further additional latching element projection, wherein, in the second position of the actuation element, the further additional latching element projection is in contact with the second unlatching element and, as a result, the further latching element is displaced to the fourth position by the second unlatching element.

This advantageously provides a particularly simple, cost-effective, robust, reliable and purely mechanical arrangement for releasing the blocking of the CPA depending on the position of the actuation element.

This displacement to the fourth position may, for example, take place in a direction that is transverse to the displacement direction or to the displacement that is caused on the latching element by means of the first unlatching element in the final plugged position. In other words, the displacement direction from the third position to the fourth position may extend substantially (e.g., +/−30°) perpendicularly to the displacement direction from the first to the second position.

According to a further aspect of the present invention, a plug-in connector for a plug-in connector assembly having a mating plug-in connector is provided.

According to an example embodiment of the present invention, the plug-in connector has a plug-in connector housing, an actuation element and a CPA, wherein the plug-in connector has a plugged position relative to the mating plug-in connector and can be plugged to the mating plug-in connector from a starting plugged position up to a final plugged position along a plugging direction, wherein the actuation element can be displaced between a first position and a second position and is designed to reduce a plug-in force when connecting the plug-in connector to the mating plug-in connector, wherein, when the actuation element is displaced from the first position to the second position, the plug-in connector is displaced from the starting plugged position to the final plugged position, wherein the CPA can be displaced between an unlocking position and a locking position along a displacement direction, wherein, in the locking position, the CPA blocks the actuation element from being displaced from the second position to the first position, wherein the CPA and the mating plug-in connector are configured relative to each other in such a way that, depending on the plugged position, the displacement of the CPA from the unlocking position to the locking position is blocked.

This has the advantageous effect that a displacement of the CPA cannot be carried out solely if, for example, (only) the actuation element is displaced to the second position. This advantageously allows the establishment of a correct connection to be better indicated by the CPA.

According to a further aspect of the present invention, a mating plug-in connector for a plug-in connector assembly having a plug-in connector with an actuation element is provided.

According to an example embodiment of the present invention, the mating plug-in connector has a mating plug-in connector housing and a CPA, wherein the plug-in connector has a plugged position relative to the mating plug-in connector and can be plugged to the mating plug-in connector from a starting plugged position up to a final plugged position along a plugging direction, wherein the CPA can be displaced between an unlocking position and a locking position along a displacement direction, wherein, in the locking position, the CPA blocks the actuation element from being displaced from the second position to the first position, wherein the CPA and the mating plug-in connector are configured relative to each other in such a way that, depending on the plugged position, the displacement of the CPA from the unlocking position to the locking position is blocked.

This has the advantageous effect that a displacement of the CPA cannot be carried out solely if, for example, (only) the actuation element is displaced to the second position. This advantageously allows the establishment of a correct connection to be better indicated by the CPA.

### BRIEF DESCRIPTION OF THE DRAWINGS

Further features and advantages of the present invention will become apparent to a person skilled in the art from the following description of exemplary embodiments with reference to the figures, which, however, are not to be interpreted as limiting the present invention.

FIGS. 1A and 1B are schematic perspective views of a plug-in connector assembly in a starting plugged position (FIG. 1A) and in a final plugged position (FIG. 1B), according to an example embodiment of the present invention.

FIG. 2 shows a schematic cross-section through a plug-in connector assembly in the final plugged position, according to an example embodiment of the present invention.

FIG. 3 is a schematic perspective view of the plug-in connector assembly of FIG. 1B, in which the actuation element is omitted.

FIG. 4 is a schematic perspective view of the mating plug-in connector of the plug-in connector assembly of FIG. 3.

FIGS. 5A to 5C show schematic cross-sections through a section of the plug-in connector assembly of the previous figures in different assembly states.

FIG. 6 is a schematic perspective and partially sectioned view of a further plug-in connector assembly in a final plugged position, according to an example embodiment of the present invention.

FIG. 7 is a schematic perspective view of the CPA of the plug-in connector assembly of FIG. 6.

### DETAILED DESCRIPTION OF EXAMPLE EMBODIMENTS

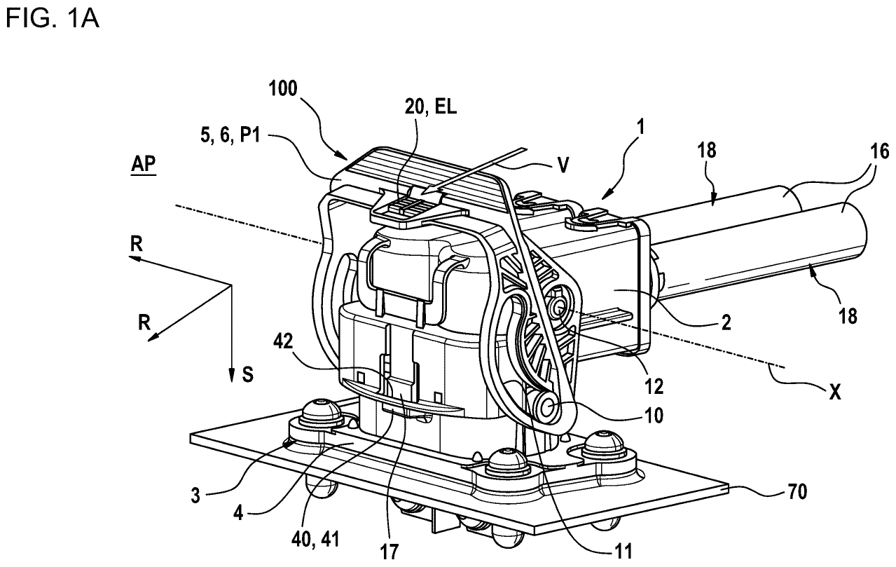

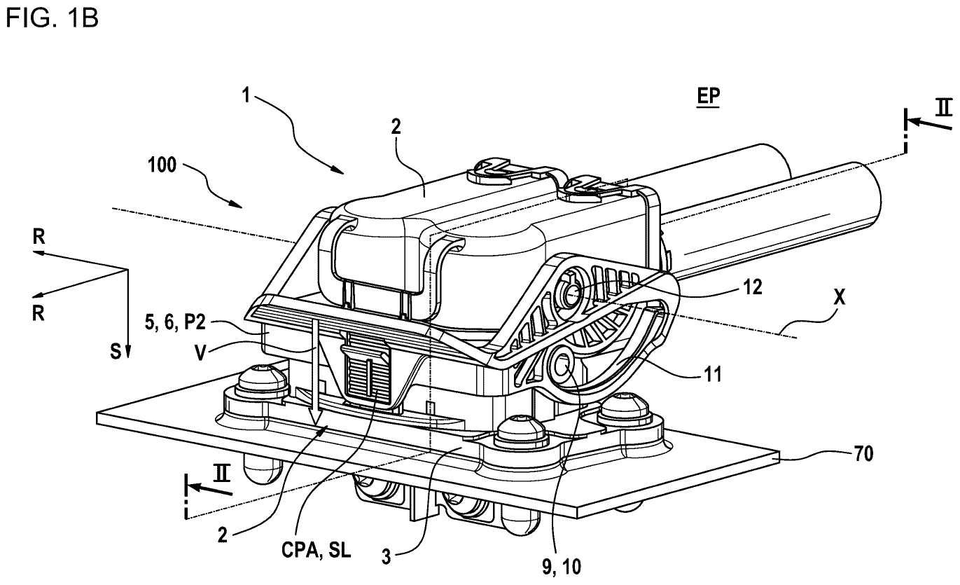

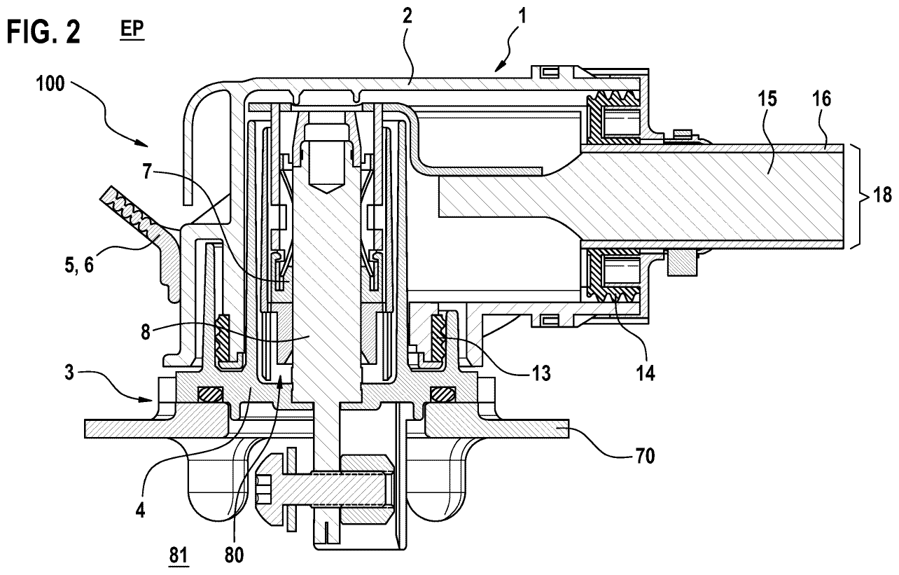

FIGS. 1A and 1B are described together below with reference to FIGS. 2, 3, 4 and 5C.

FIGS. 1A and 1B show a schematic perspective view of a plug-in connector assembly 100 in different assembly states.

The plug-in connector assembly 100 has a plug-in connector 1 with a plug-in connector housing 2, a mating plug-in connector 3 with a mating plug-in connector housing 4, an actuation element 5, and a CPA 20 (connector position assurance).

The plug-in connector 1 may, for example, be designed as a plug-in connector 1 for a high-current plug-in connector assembly (e.g., for the power transmission in an electric vehicle from a battery to an inverter and/or an electric machine), but other plug connections, e.g., multi-pin plug connections, are also possible. The plug-in connector 1 may, for example, be arranged or fastened to a cable harness. Arranged on the plug-in connector 1 here are, by way of example, two cables 18, each of which has an (electrical) line 15 (see FIG. 2) and an insulation 16 surrounding the line 15.

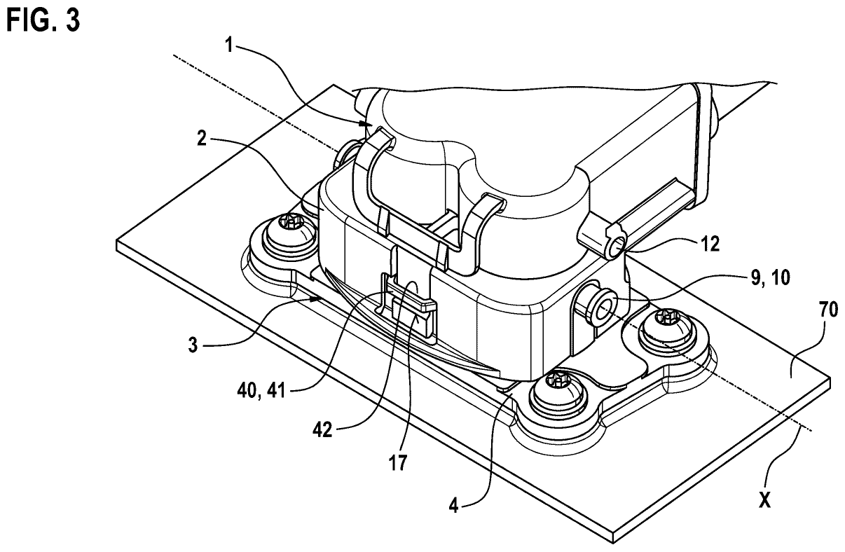

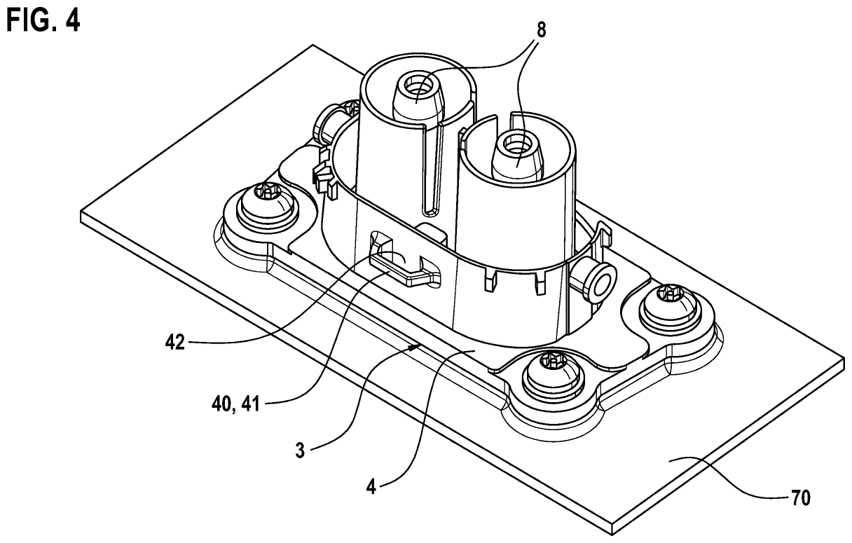

The plug-in connector housing 2 here has, by way of example, a tab, which can be designed as a latching tab 17 (see also FIG. 3), which here, by way of example, can be elastically reversibly deflected along a radial direction R perpendicular to the plugging direction S. It may here, by way of example, spring radially inward. On the mating plug-in connector housing 4, the mating plug-in connector 3 has a projection 41, which projects radially outward from the mating plug-in connector housing 3 in the manner of a shackle and here has, by way of example, an opening 42 between the projection 41 and the mating plug-in connector housing 4 (see FIG. 4). The tab, or here the latching tab 17, can be guided through the opening 42 when plugging together the plug-in connector 1 and the mating plug-in connector 3. In the final plugged position EP, it may, for example, latch under the shackle-like projection 41 (see FIG. 3). It is understood that embodiments without a latching tab 17 and/or without a projection 41 are also possible.

The mating plug-in connector 3 may, for example, be designed as a male multipoint connector or as a pin arrangement which is arranged on a component, for example a control unit or an inverter or the like. Here, the mating plug-in connector 3 is, by way of example, arranged on a component housing 70. By way of example, it is screwed or fastened to the component housing 70 by means of four screws and partially projects through a cutout in the component housing 70 into the interior of the component housing 70, while the plug-in connector 1 is, by way of example, located completely outside the component housing 70 here.

The plug-in connector 1 has a plugged position relative to the mating plug-in connector 3. It can be plugged together with the mating plug-in connector 3 from a starting plugged position AP (FIG. 1A) up to a final plugged position EP (FIG. 1B) along a plugging direction S. The starting plugged position AP of the plug-in connector 1 can already be in a state in which, unlike shown in FIG. 1A, the plug-in connector 1 is not yet placed on the mating plug-in connector 3 or is not yet coupled to it, e.g., in a state in which the plug-in connector 1 is delivered together with the cable harness.

The plug-in connector 1 may, for example, have at least one contact element 7, in this example two contact elements 7 (see FIG. 2). The mating plug-in connector 3 may have at least one mating contact element 8 (see FIG. 2); in this example, it has two mating contact elements 8 (see FIG. 4). In the final plugged position, as shown in FIG. 2, the two contact elements 7 are electrically connected to the two mating contact elements 8.

The plug-in connector 1 and the mating plug-in connector 3 are coupled, in particular mechanically and electrically coupled, to each other in the final plugged position EP. In the final plugged position EP, they are, by way of example, coupled to each other captively so that the plug-in connector 1 cannot detach from the mating plug-in connector 3 in any spatial position and under normal operating conditions, unless manual intervention is carried out to release the captive coupling. In the starting plugged position AP, however, the plug-in connector 1 and the mating plug-in connector 3 may, for example, not be captively connected to each other; they may, for example, be only loosely in contact with each other.

The actuation element 5 can be displaced between a first position P1 (FIG. 1A) and a second position P2 (FIG. 1B). It is designed to reduce a plug-in force when connecting the plug-in connector 1 and the mating plug-in connector 3, wherein, when the actuation element 5 is displaced from the first position P1 to the second position P2, the plug-in connector 1 is displaced from the starting plugged position AP to the final plugged position EP, provided that the plug-in connector 1 is correctly placed on the mating plug-in connector 3. This is the case if the plug-in connector 1 is plugged to or placed on the mating plug-in connector 3 in its starting plugged position AP, as shown in FIG. 1A.

In this exemplary embodiment, the actuation element 5 is arranged on the plug-in connector 1, here, by way of example, on the plug-in connector housing 2.

The actuation element 5 is here, by way of example, designed as a lever 6 that can be rotated about an axis X. The lever 6 is here, by way of example, rotatably mounted on a bolt 12, wherein the bolt 12 is here, by way of example, arranged on the plug-in connector housing 2. Instead of a bolt 12, a shaft may also be provided.

The actuation element 5 is designed to interact with a structure 9, which is arranged here, by way of example, on the mating plug-in connector 3, in such a way that, when the actuation element 5 is displaced from the first position P1 to the second position P2, the plug-in connector 1 is displaced from the starting plugged position AP to the final plugged position EP. In this exemplary embodiment, the actuation element 5 has a guide 11 on each of two sides (on two lever arms), which interacts with structures 9 designed here as pins 10.

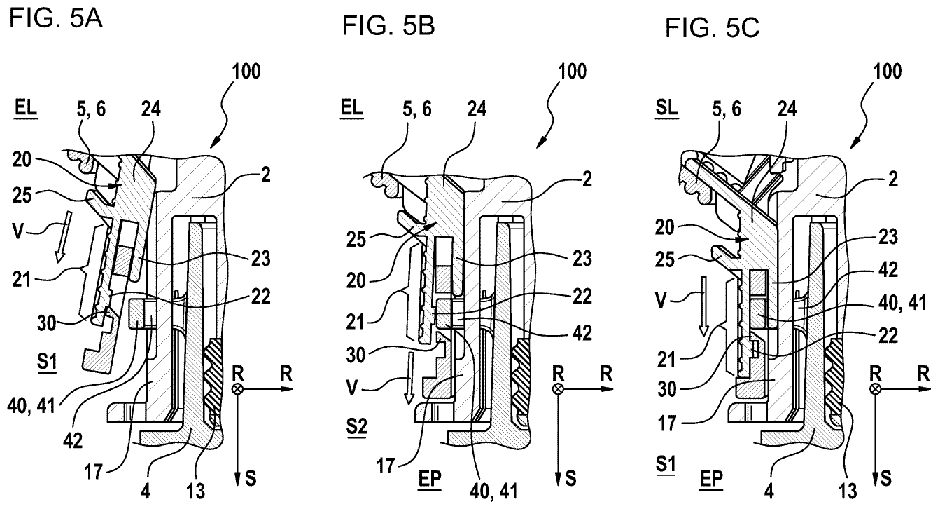

The CPA 20 can be displaced between an unlocking position EL and a locking position SL along a (first) displacement direction V, wherein, in the locking position SL, the CPA 20 blocks the actuation element 5 from being displaced from the second position P2 to the first position P1 (see FIG. 5C in this respect). In this exemplary embodiment, the CPA 20 and the mating plug-in connector 3 are configured relative to each other in such a way that, depending on the plugged position, the displacement of the CPA 20 from the unlocking position EL to the locking position SL is blocked, as described, by way of example, in more detail below in connection with FIGS. 5A to 5C.

It is provided here, by way of example, that a displacement of the CPA 20 from the unlocking position EL to the locking position SL is blocked before the final plugged position EP is reached (see FIG. 5A). It is provided here, by way of example, that a displacement of the CPA 20 from the unlocking position EL to the locking position SL is made possible in the final plugged position EP (see FIGS. 5B and 5C).

The CPA 20 is arranged here, by way of example, on the actuation element 5. Alternatively or additionally, it may be arranged on the plug-in connector housing 2 or on the plug-in connector 1. Alternatively or additionally, it may be arranged on the mating plug-in connector 3, in particular on the mating plug-in connector housing 4.

FIG. 2 shows a schematic cross-section through a plug-in connector assembly 100 in the final plugged position EP. The section is made through a contact element 7, the associated mating contact element 8 and the associated cable 18 with the line 15 and the insulation 16 (see FIG. 1B). The CPA 20 is therefore not visible here.

In the plug-in connector housing 2, the plug-in connector 1 has a sealing element 13, which is designed here as a radial seal by way of example. The sealing element 13 is arranged at a first end of the plug-in connector housing 2 that faces the mating plug-in connector 3. In the final plugged position EP, the sealing element 13 seals an interior space 80 of the plug-in connector assembly 100 against ingress of dirt, grime, dust, moisture and other fluid media from an external environment 81 of the plug-in connector assembly 100. The sealing element 13 is in contact with the mating plug-in connector housing 4.

The plug-in connector 1 also has a further sealing element 14, which is arranged at a second, cable-side end. The further sealing element 14 is also designed here, by way of example, as a radial seal and is in contact with the insulation 16 of the cable 18. It thus seals the interior space 80 against ingress of dirt, grime, dust, moisture and other fluid media from the external environment 81 of the plug-in connector assembly 100. The further sealing element 14 may also be arranged on the cable 18 before mounting the cable 18 and can be guided into the plug-in connector housing 2 when the cable 18 is mounted on or in the plug-in connector housing 2.

FIG. 3 is a schematic perspective view of the plug-in connector assembly 100 in the final plugged position of FIG. 1B, in which the actuation element 5 is omitted for reasons of clarity (the actuation element 5 would be in the second position P2). As described above, the projection 41 with the opening 42 on the mating plug-in connector housing 4 can be clearly seen. It can also be clearly seen that the latching tab 17 is inserted from above through the opening 42. In the final plugged position EP, the projection 41 may, for example, serve as an undercut for the latching tab 17, which has a latching lug protruding radially outward. In this exemplary embodiment, the plug-in connector 1 may, for example, initially be arranged or fixed solely thereby in a captive manner to the mating plug-in connector 3 in the final plugged position EP.

FIG. 4 shows a schematic perspective view of the mating plug-in connector 3 of the plug-in connector assembly 100 of FIG. 3. The projection 41 arranged on the mating plug-in connector housing 4 and the opening 42 formed here, by way of example, on the projection 41 can be clearly seen. The projection 41 is here designed in the shape of a shackle and closed in the shape of a ring (together with a part of the mating plug-in connector housing 4).

FIGS. 5A to 5C show schematic cross-sections through a section of the plug-in connector assembly 100 from the previous figures in different assembly states and are described together below. The figures are not to scale. In particular, the function of the latching tab 17 is not shown recognizably here in order to better illustrate the function of the CPA 20. The latching tab 17 is shown here only in the form of a tab, which also represents a possible embodiment.

FIGS. 5A to 5C show, by way of example, how the CPA 20 and here, by way of example, the mating plug-in connector 3 are configured relative to each other in such a way that, depending on the plugged position, the displacement of the CPA 20 from the unlocking position EL to the locking position SL is blocked.

This has the advantageous effect that the CPA 20 cannot be transferred from the unlocking position EL to the locking position solely on the basis of a position of the actuation element 5. If such a displacement of the CPA 20 were made possible solely depending on the position of the actuation element 5, there would be a risk that, even before the plug-in connector 1 and the mating plug-in connector 3 are plugged together, the actuation element 5 is displaced to a position (e.g., to the second position P2) in which the CPA 20 can be displaced, and the CPA 20 is then displaced from the unlocking position EL to the locking position SL. If the plug-in connector 1 were then to be plugged together with the mating plug-in connector 3, an operator could mistakenly assume that the plug-in connector assembly 100 is correctly formed, which could subsequently lead to malfunctions. It could also be possible for the CPA 20 to be displaceable if the actuation element has arrived at a desired position (e.g., the second position P2) when plugging together the plug-in connector 1 and the mating plug-in connector 3, without the final plugged position EP actually being reached. In this case, the displaceability of the CPA 20 would also falsely indicate to an operator that the plug connection is correctly established, even though this is not yet the case. By virtue of the CPA 20 being blocked from being displaced depending on the plugged position between the plug-in connector 1 and the mating plug-in connector 3, these possible intentional or unintentional operating errors can be counteracted.

As shown in FIGS. 5A to 5C by way of example, it may be provided that a displacement of the CPA 20 from the unlocking position EL to the locking position SL is blocked before the final plugged position EP is reached (see FIG. 5A). It is here furthermore provided, by way of example, that a displacement of the CPA 20 from the unlocking position EL to the locking position SL is made possible in the final plugged position EP (see FIGS. 5B and 5c), in particular if the actuation element 5 is approximately in the second position P2.

The CPA 20 here has, by way of example, a latching element 21, which can be latched to a mating element 30. The mating element 30 is formed here on the actuation element 5 and acts as an undercut. The latching element 21 can be (here, by way of example, elastically reversibly) deflected between a first position S1 (FIGS. 5A and 5C) and a second position S2 (FIG. 5B). In the first position S1, the latching element 21 is latched to the mating element 30 and the CPA 20 is blocked from being displaced from the unlocking position EL to the locking position SL (FIG. 5A). In the second position S2, the latching element 21 is not latched to the mating element 30. By way of example, in the second position S2 of the latching element 21, the CPA 20 can thus be displaced here from the unlocking position EL to the locking position SL (FIGS. 5B and 5C).

In the starting plugged position AP, the latching element 21 is in the first position S1. In this exemplary embodiment, a first unlatching element 40 is arranged on the mating plug-in connector housing 4 and is designed in such a way that, in the final plugged position EP, the latching element 21 is displaced to the second position S2 by means of the first unlatching element 40.

The first unlatching element 40 is here, by way of example, formed by the projection 41 on the mating plug-in connector housing 4, wherein, as described above, the projection 41 here, by way of example, projects outward from the plug-in connector housing 2 or from the mating plug-in connector housing 4 in a radial direction R perpendicular to the plugging direction S.

The latching element 21 here has, by way of example, a latching element projection 22, which projects radially inward here (pointing toward the mating plug-in connector housing 4), wherein, in the final plugged position EP, the latching element projection 22 is in contact with the first unlatching element 40 (here: the projection 41) and is displaced, in particular displaced radially outward, to the second position S2 by the first unlatching element 40. This displacement to the second position S2 takes place in particular if the CPA 20 is in the unlocking position EL.

The CPA 20 here has, by way of example, a base 24, from which the latching element 21 projects. The latching element 21 is here, by way of example, designed as a latching arm. The latching arm here is designed to be self-supporting, with one end being fastened to the base 24. The latching arm is here, by way of example, designed to be elastically reversibly deflectable between the first position S1 and the second position S2. The CPA 20 furthermore has a handle element 25. Finally, the CPA 20 also has a locking element 23, which is also designed here as a self-supporting arm and extends approximately in parallel with the latching element 21.

When the CPA 20 is displaced from the unlocking position EL to the locking position SL, the locking element 23 is guided through the opening 42 (FIG. 5C) and thus, in interaction with the inner side of the projection 41, blocks a displacement of the actuation element 5 from the second position P2 toward the first position P1.

In this exemplary embodiment, the projection 41 thus has a triple function. On the one hand, it is designed, in the final plugged position EP, to hold the plug-in connector 1 captively in interaction with the latching tab 17 thereof on the mating plug-in connector. At the same time, with its surface projecting radially outward (i.e., with its projecting part), it serves to displace the latching element 21 from the first position S1 to the second position S2, depending on the plugged position. Finally, by means of an interaction of its inward-projecting surface with the locking element 23 of the CPA 20, it has the effect that, in the locking position SL of the CPA 20, the actuation element 5 cannot be moved out of the second position P2 in the direction of the first position P1.

By means of the handle element 25, the latching element 21 can in principle also be displaced from the first position S1 to the second position S2, for example by exerting a pressure on the handle element in the direction opposite to the displacement direction V so that the handle element 25 is tilted together with the latching element 21. As can be seen in FIGS. 5A and 5B, the handle element 25 however abuts against a corresponding surface of the actuation element 5 as long as the CPA 20 is in the unlocking position EL. Thus, in the unlocking position EL of the CPA 20, the handle element 25 cannot be tilted by pressure in the direction opposite to the displacement direction V and, in the unlocking position EL of the CPA 20, the latching element 21 thus also cannot be displaced from the first position S1 to the second position S2 by means of the handle element 25. This is only possible after the CPA 20 has been transferred to the locking position SL and the handle element 25 thus no longer abuts against the corresponding surface of the actuation element 5.

If the CPA 20 has been displaced to the locking position SL, it can also be blocked by means of the latching element 21 from being displaced from the locking position SL to the unlocking position EL (see FIG. 5C). This is achieved here, by way of example, by the latching element projection 22, which here engages behind a further undercut (on the rear side of the mating element 30 here) after the latching element 21 has sprung back to the first position S1. This blockage may, for example, be lifted by a manual operation by an operator (e.g., as described above using the handle element 25 of the CPA 20) if, for example, the plug-in connector 1 is to be released again from the mating plug-in connector 3. For this purpose, the latching element 21 is then, for example, displaced manually to the second position S2, and the CPA 20 is subsequently displaced from the locking position SL to the unlocking position EL. Subsequently, the actuation element 5 can be displaced from the second position P2 to the first position P1 and the plug-in connector 1 can in this way be released from the mating plug-in connector 3.

FIG. 5A shows a state when plugging together the plug-in connector 1 and the mating plug-in connector 3 in which the final plugged position EP is almost, but not yet completely, reached. The actuation element 5 is approximately but not yet completely in the second position P2. The CPA 20 is in the unlocking position EL. It can furthermore be seen that the latching tab 17 extends through the opening 42 of the projection 41.

FIG. 5B shows the state in which the final plugged position EP is reached and the projection 41 as the first unlatching element 40 has displaced the latching element 21 to the second position S2 by means of the latching element projection 22 and has thus brought it out of engagement with the mating element 30. As a result, the CPA 20 is now no longer blocked from being displaced from the unlocking position EL to the locking position SL. The displacement of the latching element 21 to the second position S2 may also be independent of the actuation element 5 exactly reaching the second position P2. This may, for example, take place by a suitable choice of the length of the first unlatching element 40. However, the CPA 20 may, for example, also be arranged on the plug-in connector housing 2 and not on the actuation element 5.

FIG. 5C shows the state in which the CPA 20 has now been displaced to the locking position SL along the displacement direction V (here: downward) after the final plugged position EP has been reached. The latching element 21 has now returned to the first position S1 and the latching element projection 22 is now latched to the other side of the mating element 30, namely for preventing the CPA 20 from being displaced from the locking position SL to the unlocking position EL. The handle element 25 may now, for example, be used to displace the latching element 21 back to the second position S2 and thus to release the blocking of the CPA 20 from being displaced from the locking position SL to the unlocking position EL.

The locking element 23 may have an inclined surface so that, when the CPA 20 is displaced from the unlocking position EL to the locking position SL, in interaction with the inner side of the projection 41, the locking element pulls the actuation element 5 to the second position P2, provided that, for example, the actuation element 5 has not yet fully reached the second position P2 due to manufacturing tolerances or temperature-related tolerances when the final plugged position EP is reached.

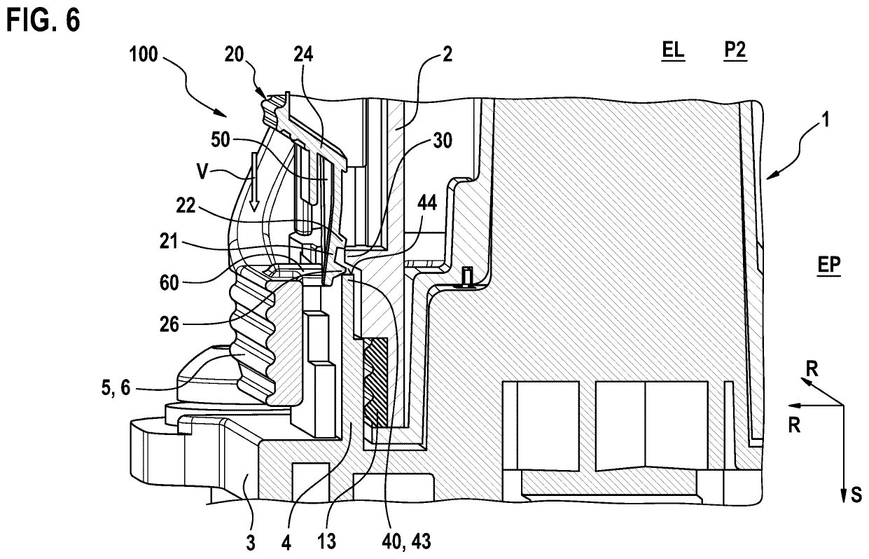

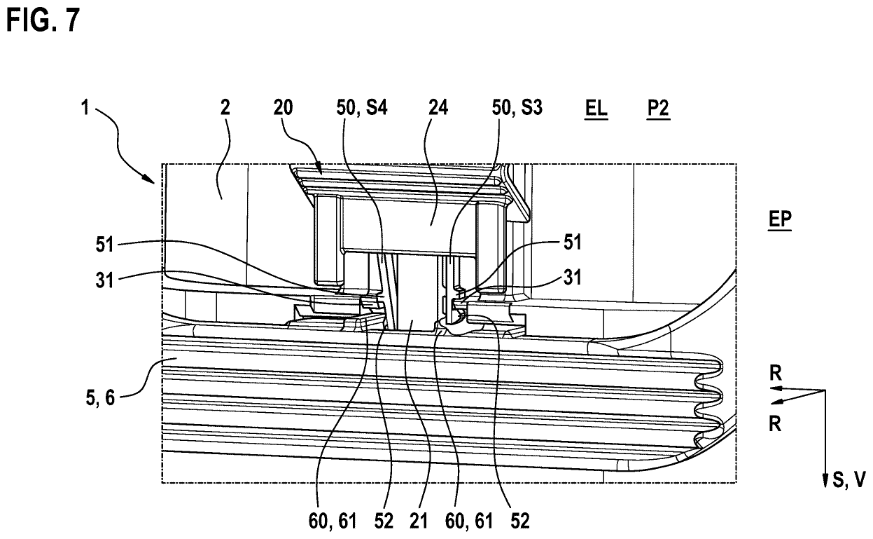

FIGS. 6 and 7 show a schematic perspective and partially sectioned view of a further plug-in connector assembly 100 (FIG. 6) and a schematic perspective view of the CPA 20 of this plug-in connector assembly 100 (FIG. 7) and are described together below.

In the plug-in connector assembly 100 of FIGS. 6 and 7, the CPA 20 is arranged on the plug-in connector housing 2.

The CPA 20 and the actuation element 5 are designed to cooperate with each other in such a way that a displacement of the CPA 20 from the unlocking position EL to the locking position SL depends on a position of the actuation element 5 (in addition to the dependence on the plugged position), wherein, in the first position P1 of the actuation element 5, the CPA 20 cannot be displaced from the unlocking position EL to the locking position SL. Here, by way of example, it is provided that, in the second position P2 of the actuation element 5 and with the simultaneous presence of the final plugged position EP, the CPA 20 can be displaced from the unlocking position EL to the locking position SL.

This means that a single, purely mechanical element (here: the CPA 20) can ensure or indicate that, on the one hand, the final plugged position EP has been reached and, on the other hand, the actuation element 5 is in the second position P2. This makes it possible to check the correct assembly of the plug-in connector 1 and the mating plug-in connector 3 and the correct formation of the plug connection between the plug-in connector 1 and the mating plug-in connector 3 particularly simply and safely.

The CPA 20 has a further latching element 50 (here: two further latching elements 50, see FIG. 7), which can be latched to a further mating element 31 (here: two further mating elements 31, see FIG. 7). The further latching elements 50 can be deflected between a third position S3 and a fourth position S4, wherein the further latching elements 50 in the third position S3 are latched to the respectively assigned further mating element 31 and the CPA 20 is blocked from being displaced from the unlocking position EL to the locking position SL. It is sufficient for blocking if only a single further latching element 50 is in the third position S3. In the fourth position S4, the further latching elements 50 are each not latched to the assigned further mating element 31.

If all further latching elements 50 are in the fourth position, the CPA 20 can in principle be displaced from the unlocking position EL to the locking position SL or is in this case no longer blocked. In the first position P1 of the actuation element 5, the further latching elements 50 are in the third position S3. A second unlatching element 60 is provided (here: two second unlatching elements 60), which is arranged here on the actuation element 5 (here: both second unlatching elements 60 are arranged on the actuation element 5). The two second unlatching elements 60 are designed in such a way that, in the second position P2 of the actuation element 5, the further latching elements 50 are displaced to the fourth position S4 by means of the second unlatching elements 60.

In this exemplary embodiment, it is provided that the further latching elements 50 each have a further latching element projection 51. The further latching element projections 51 project here, by way of example, pointing away from one another, radially laterally outward from the further latching element 50. The further latching element projections 51 here latch in the third position S3 of the further latching elements 50, by way of example each to one of the further mating elements 31.

Furthermore, by way of example, a further additional latching element projection 52 is provided on each of the two further latching elements 50. The further additional latching element projections 52 are spaced apart from the further latching element projections 51 when viewed along the plugging direction S.

Each of these further additional latching element projections 52 here projects from the further latching element 50 radially to the side, wherein the further additional latching element projections 52 of the two further latching elements 50 point away from one another here. The two further additional latching element projections 52 here each have, by way of example, an inclined surface onto which the second unlatching elements 60 run when the actuation element 5 has approximately reached the second position P2. If the actuation element 5 is then completely displaced to the second position P2, the two further additional latching element projections 52 here are displaced laterally inward (toward one another) and, as a result, the two further latching elements 50 are displaced from the third position S3 to the fourth position S4. In principle, other designs are also possible in order to cause a displacement of the further latching elements 50 from the third position S3 to the fourth position S4.

In other words, the further latching element 50 has a further additional latching element projection 52, wherein, in the second position P2 of the actuation element 5, the further additional latching element projection 52 is in contact with the second unlatching element 60 and, as a result, the further latching element 50 is displaced (here: indirectly) to the fourth position S4 by the second unlatching element 60. The displacement here, by way of example, takes place transversely to the displacement which is caused on the latching element 21 by means of the first unlatching element 40 in the final plugged position EP, wherein other displacement directions are however also possible, e.g., in the direction of the plug-in connector housing 2.

In FIG. 7, for illustrating the effect of the third position S3 and the fourth position S4, the further latching element 50 shown on the right is shown in the third position S3 (latched position) and the further latching element 50 shown on the left is shown in the fourth position S4 (no longer latched position). In the second position P2 of a defect-free actuation element 5, both further latching elements 50 should be in the fourth position S4.

The second unlatching elements 60 here are each, by way of example, designed as a further projection 61 on the actuation element 5, which projection in particular projects from the actuation element 5 in a radial direction R perpendicular to the plugging direction S (here: in the second position P2, facing the mating plug-in connector housing 4).

In this embodiment, the first unlatching element 40 is formed by a wall portion 43 of the mating plug-in connector housing 4. When plugging together the plug-in connector 1 and the mating plug-in connector 3 in the final plugged position EP, the latching element 21 of the CPA 20 runs against an end face 44 of this wall portion 43 by means of an additional latching element projection 26, which here has an inclined surface. The latching element 21 is thereby displaced from the first position S1 to the second position S2 (see FIG. 6). As a result, the latching element projection 22 is disengaged from the assigned mating element 30 of the plug-in connector housing 2 (see FIG. 6). In this way, in the final plugged position EP, the blocking of the CPA 20 from being displaced from the locking position SL to the unlocking position EL by the latching element 21 is lifted.

If both the final plugged position EP and the second position P2 are thus reached, the latching element 21 and the two further latching elements 50 of the CPA 20 can be released from their latching to the mating element 30 or the two further mating elements 31, and a displacement of the CPA 20 from the unlocking position EL to the locking position SL is made possible. This possibility of displacement is a sure indication for an operator that the plug-in connector 1 and the mating plug-in connector 3 are correctly plugged together. Furthermore, the CPA 20 10 displaced to the locking position SL is a sign, for example during visual quality control, that the plug connection is correctly established.

1-13. (canceled)

14. A plug-in connector assembly, comprising:
a plug-in connector with a plug-in connector housing;
a mating plug-in connector with a mating plug-in connector housing;
an actuation element; and
a connector position assurance (CPA);
wherein the plug-in connector has a plugged position relative to the mating plug-in connector and can be plugged to the mating plug-in connector from a starting plugged position up to a final plugged position along a plugging direction,
wherein the actuation element can be displaced between a first position and a second position and is configured to reduce a plug-in force when connecting the plug-in connector to the mating plug-in connector,
wherein, when the actuation element is displaced from the first position to the second position, the plug-in connector is displaced from the starting plugged position to the final plugged position, wherein the CPA can be displaced between an unlocking position and a locking position along a displacement direction,
wherein, in the locking position, the CPA blocks the actuation element from being displaced from the second position to the first position, and
wherein the CPA and: (i) the mating plug-in connector or (ii) the plug-in connector, are configured relative to each other in such a way that, depending on the plugged position, the displacement of the CPA from the unlocking position to the locking position is blocked.

15. The plug-in connector assembly according to claim 14,
wherein the displacement of the CPA from the unlocking position to the locking position is blocked before the final plugged position is reached, and
wherein, in the final plugged position, the displacement of the CPA from the unlocking position to the locking position is made possible.

16. The plug-in connector assembly according to claim 14, wherein:
the CPA is arranged on the actuation element, or
the CPA is arranged on the plug-in connector housing, or
the CPA is arranged on the mating plug-in connector housing.

17. The plug-in connector assembly according to claim 14, wherein the actuation element is configured as a slider and/or as a lever that can be rotated about an axis.

18. The plug-in connector assembly according to claim 14,
wherein the CPA has a latching element, which can be latched to a mating element,
wherein the latching element can be deflected between a first position and a second position,
wherein, in the first position, the latching element is latched to the mating element and blocks the CPA from being displaced from the unlocking position to the locking position,
wherein, in the second position, the latching element is not latched to the mating element and the CPA can be displaced from the unlocking position to the locking position,
wherein, in the starting plugged position, the latching element is in the first position,
wherein a first unlatching element is arranged on the plug-in connector housing or on the mating plug-in connector housing and is configured in such a way that, in the final plugged position, the latching element is displaced to the second position using the first unlatching element.

19. The plug-in connector assembly according to claim 18,
wherein the first unlatching element is a projection on the plug-in connector housing or on the mating plug-in connector housing, and
wherein the projection projects outward from the plug-in connector housing or from the mating plug-in connector housing in a radial direction perpendicular to the plugging direction.

20. The plug-in connector assembly according to claim 14,
wherein the latching element has a latching element projection which projects radially inward, and
wherein, in the final plugged position, the latching element projection is in contact with the first unlatching element and, as a result, the latching element is displaced radially outward, to the second position by the first unlatching element, when the CPA is in the unlocking position.

21. The plug-in connector assembly according to claim 14, wherein the CPA and the actuation element are configured to cooperate with each other in such a way that a displaceability of the CPA from the unlocking position to the locking position depends on a position of the actuation element, and wherein, in the first position of the actuation element, the CPA cannot be displaced from the unlocking position to the locking position, wherein, in the second position of the actuation element and with the simultaneous presence of the final plugged position, the CPA can be displaced from the unlocking position to the locking position.

22. The plug-in connector assembly according to claim 14,
wherein the CPA has a further latching element, which can be latched to a further mating element,
wherein the further latching element can be deflected between a third position and a fourth position,
wherein, in the third position, the further latching element is latched to the further mating element and blocks the CPA from being displaced from the unlocking position to the locking position,
wherein, in the fourth position, the further latching element is not latched to the further mating element and the CPA can be displaced from the unlocking position to the locking position,
wherein, in the first position of the actuation element, the further latching element is in the third position, and
wherein a second unlatching element is provided and is arranged on the actuation element and is configured in such a way that, in the second position of the actuation element, the further latching element is displaced to the fourth position using the second unlatching element.

23. The plug-in connector assembly according to claim 22, wherein the second unlatching element is a further projection on the actuation element, which projects from the actuation element in a radial direction perpendicular to the plugging direction.

24. The plug-in connector assembly according to claim 22,
wherein the further latching element has a further additional latching element projection, and
wherein, in the second position of the actuation element, the further additional latching element projection is in contact with the second unlatching element and, as a result, the further latching element is displaced to the fourth position by the second unlatching element, transversely to the displacement caused on the latching element using the first unlatching element in the final plugged position.

25. A plug-in connector for a plug-in connector assembly having a mating plug-in connector, the plug-in connector comprising:
a plug-in connector housing;
an actuation element; and
a connector position assurance (CPA);
wherein the plug-in connector has a plugged position relative to the mating plug-in connector and can be plugged to the mating plug-in connector from a starting plugged position up to a final plugged position along a plugging direction,
wherein the actuation element can be displaced between a first position and a second position and is configured to reduce a plug-in force when connecting the plug-in connector to the mating plug-in connector,
wherein, when the actuation element is displaced from the first position to the second position, the plug-in connector is displaced from the starting plugged position to the final plugged position, wherein the CPA can be displaced between an unlocking position and a locking position along a displacement direction,
wherein, in the locking position, the CPA blocks the actuation element from being displaced from the second position to the first position, and
wherein the CPA and the mating plug-in connector are configured relative to each other in such a way that, depending on the plugged position, the displacement of the CPA from the unlocking position to the locking position is blocked.

26. A mating plug-in connector for a plug-in connector assembly having a plug-in connector with an actuation element, the mating plug-in connector comprising:
a mating plug-in connector housing; and
a connector position assurance (CPA);
wherein the plug-in connector has a plugged position relative to the mating plug-in connector and can be plugged to the mating plug-in connector from a starting plugged position up to a final plugged position along a plugging direction,
wherein the CPA can be displaced between an unlocking position and a locking position along a displacement direction,
wherein, in the locking position, the CPA blocks the actuation element from being displaced from the second position to the first position,
wherein the CPA and the mating plug-in connector are configured relative to each other in such a way that, depending on the plugged position, the displacement of the CPA from the unlocking position to the locking position is blocked.
